(19) United States
(12) Patent Application Publication
(10) Pub. No.: US 2016/0074753 A1
(43) Pub. Date: Mar. 17, 2016

(54) CONTROL OF PHYSICS ENGINE

(71) Applicant: KING.COM LIMITED, St. Julians (MT)

(72) Inventors: Daniel Frostberg, Stockholm (SE); Linus Cumselius, Stockholm (SE)

(21) Appl. No.: 14/484,445

(22) Filed: Sep. 12, 2014

(51) Int. Cl. A63F 13/57

(52) U.S. Cl. CPC A63F 13/57

(57) ABSTRACT

A system for providing a computer implemented game having a plurality of game objects which in use are displayed on a display, said system comprising: an input configured to receive an input from a user; a game engine part configured to be responsive to the received input; a physics engine configured to control movement of said plurality of game objects, each game object being classified as moving or stationary; and a position control part configured to receive physics engine information from said physics engine and based on said physics engine information to determine if a game object classified as moving is to be reclassified as stationary and if so to provide classification information to said physics engine.

### FIELD OF THE INVENTION

Some embodiments may relate to a system for providing a computer implemented game having a plurality of game objects which in use are displayed on a display.

### BACKGROUND OF THE INVENTION

Computer implemented games are a well-known category of games that allow a player to interact with a computing device to cause the processor to perform certain functions and typically display a result on a screen or other display device.

Different types of games have evolved from classical arcade games in to games that can be played on a handheld device such as a smartphone, tablet or personal computer. Some games are also connected to the Internet and the player can play against or compare score with other users in multiplayer mode.

A common genre of casual games is so-called “bubble-shooter” games. In a typical bubble shooter game the player operates an object launcher that can shoot an object into the game board. The game board is typically populated with a number of game objects already. The game objects are of different types. The launched object will travel upwardly, towards the game objects already on the game board and stick to the objects on the game board. If the launched object hits a game object of the same type that already has another game element of the same type adjacent to it the three game objects will disappear from the game board.

### SUMMARY OF INVENTION OF THE INVENTION

In one embodiment, there is provided a system for providing a computer implemented game having a plurality of game objects which in use are displayed on a display, said system comprising: an input configured to receive an input from a user; a game engine part configured to be responsive to the received input; a physics engine configured to control movement of said plurality of game objects, each game object being classified as moving or stationary; and a position control part configured to receive physics engine information from said physics engine and based on said physics engine information to determine if an game object classified as moving is to be reclassified as stationary and if so to provide classification information to said physics engine.

The position control part may be configured to determine if a game object which is to be reclassified as stationary is to have its position adjusted.

The game objects may be arranged in a defined pattern and said position control part may be configured to adjust a position of said game object to be reclassified to conform to said defined pattern.

The defined pattern may be a hexagonal field pattern.

The position control part may be configured to provide adjusted position information, such that said adjusted position information is used by said physics engine.

The physics engine may be configured to use said adjusted position information to update a position of said respective game object and to use the updated position of said respective object when controlling movement of another game object.

The physics engine and said position control part may be configured to perform an iterative process to determine if a game object is to be reclassified as stationary.

The position control part may receive from the physics engine first physics engine information, said position control part may be configured to determine based on said first physics engine information if a game object is to be reclassified and if not to receive second physics engine information from the physics engine and to use said first and second physics engine information to determine if a game object is to be reclassified.

If it is determined that an object is not be reclassified, said position control part is configured to receive further physics engine information and use current and further physics engine information to determine if a game object is to be reclassified.

The position control part may be configured to determine that a game object is to be reclassified as stationary if one of a plurality of pre-defined conditions is satisfied.

The position control part may be configured to determine if the position of a game object which is to be reclassified as stationary has an allowed configuration with respect to one or more other game objects and/or a different game element.

The game engine may be configured to determine if one or more game objects satisfy one or more rules and if so to remove said one or more game objects.

The game engine may be configured to determine if one or more game objects satisfy one or more rules only if all of said game objects have been classified as stationary.

After said one or more game objects has been removed, said position control part may be configured to again receive physic engine information from said physics engine and based on said physics engine information to determine if an object classified as moving is to be reclassified as stationary and if so to provide said classification information to said physics engine.

The game engine part may comprise said position control part.

The position control part may be provided by an algorithm which is configured to run on a processor.

In another embodiment, there is provided, in combination, a physics engine and position control part, outside said physics engine, said physics engine configured to control movement of a plurality of game objects which are to be displayed, each game object being classified as moving or stationary and said position control part is configured to receive physics engine information from said physics engine and based on said physics engine information to determine if an game object classified as moving is to be reclassified as stationary and if so to provide classification information to said physics engine.

In another embodiment, there is provided a method for providing a computer implemented game having a plurality of game objects which in use are displayed on a display, said method comprising: controlling movement of said plurality of game objects using a physics engine, each game object being classified as moving or stationary; receiving physics engine information from said physics engine; and determining based on said physics engine information if a game object classified as moving is to be reclassified as stationary and if so providing classification information to said physics engine.

The method may comprise determining if a game object which is to be reclassified as stationary is to have its position adjusted. This determining may be performed outside the physics engine.

The game objects may be arranged in a defined pattern and method comprises adjusting a position of said game object to be reclassified to conform to said defined pattern.

The defined pattern may be a hexagonal field pattern.

The method may comprise providing adjusted position information, such that said adjusted position information is used by said physic engine.

The method may comprise using, in said physics engine, said adjusted position information to update a position of said respective game object and to use the updated position of said respective object when controlling movement of another game object.

The method may comprise receiving first physics engine information, determine based on said first physics engine information if a game object is to be reclassified and if not to receive second physics engine information and to use said first and second physics engine information to determine if a game object is to be reclassified.

If it is determined that an object is not be reclassified, said method may comprise receiving further physics engine information and using current and further physics engine information to determine if a game object is to be reclassified.

The method may comprise determining that a game object is to be reclassified as stationary if one of a plurality of pre-defined conditions is satisfied.

The method may comprise determining if the position of a game object, which is to be reclassified as stationary, has an allowed configuration with respect to one or more other game objects and/or a different game element.

The method may comprise determining by a game engine if one or more game objects satisfy one or more rules and if so to remove said one or more game objects.

The method may comprise determining if one or more game objects satisfy one or more rules only if all of said game objects have been classified as stationary.

In some embodiments, a computer program is provided, said computer program comprising computer code which when run causes any of the above methods to be performed.

After said one or more game objects has been removed, the method may comprise receiving physics engine information from said physics engine and based on said physics engine information to determine if an object classified as moving is to be reclassified as stationary and if so to provide said classification information to said physics engine.

According to another aspect, there is provided an apparatus for providing a computer implemented game having a plurality of game objects which in use are displayed on a display said apparatus comprising at least one processor and at least one memory including computer code for one or more programs, the at least one memory and the computer code configured, with the at least one processor, to cause the apparatus at least to: control movement of said plurality of game objects using a physics engine, each game object being classified as moving or stationary; receive physics engine information from said physics engine; and determine based on said physics engine information if a game object classified as moving is to be reclassified as stationary and if so providing classification information to said physics engine.

The at least one memory and the computer code may be configured, with the at least one processor, to determine if a game object which is to be reclassified as stationary is to have its position adjusted. This determining may be performed outside the physics engine.

The game objects may be arranged in a defined pattern and the at least one memory and the computer code may be configured, with the at least one processor, to adjust a position of said game object to be reclassified to conform to said defined pattern.

The defined pattern may be a hexagonal field pattern.

The at least one memory and the computer code may be configured, with the at least one processor, to provide adjusted position information, such that said adjusted position information is used by said physic engine.

The at least one memory and the computer code may be configured, with the at least one processor, to use, in said physics engine, said adjusted position information to update a position of said respective game object and to use the updated position of said respective object when controlling movement of another game object.

The at least one memory and the computer code may be configured, with the at least one processor, to receive first physics engine information, determine based on said first physics engine information if a game object is to be reclassified and if not to receive second physics engine information and to use said first and second physics engine information to determine if a game object is to be reclassified.

The at least one memory and the computer code may be configured, with the at least one processor, to determine that a game object is to be reclassified as stationary if one of a plurality of pre-defined conditions is satisfied.

The at least one memory and the computer code may be configured, with the at least one processor, to determine if the position of a game object which is to be reclassified as stationary has an allowed configuration with respect to one or more other game objects and/or a different game element.

The at least one memory and the computer code may be configured, with the at least one processor, to determine if one or more game objects satisfy one or more rules and if so to remove said one or more game objects from the image displayed.

The at least one memory and the computer code may be configured, with the at least one processor, to determine if one or more game objects satisfy one or more rules only if all of said game objects has been classified as stationary.

After said one or more game objects has been removed, the at least one memory and the computer code may be configured, with the at least one processor, to receive physics engine information from said physics engine and based on said physics engine information to determine if an object classified as moving is to be reclassified as stationary and if so to provide said classification information to said physics engine.

A computer program product for providing a computer implemented game having a plurality of game objects which in use are displayed on a display, said computer program product comprising computer executable code which when run is configured to: control movement of said plurality of game objects using a physics engine, each game object being classified as moving or stationary; receive physics engine information from said physics engine; and determine based on said physics engine information if a game object classified as moving is to be reclassified as stationary and if so providing classification information to said physics engine.

The computer executable instructions may be run on one or more processors.

A non-transitory computer readable medium, comprising computer executable instructions for providing a computer implemented game having a plurality of game objects which in use are displayed on a display, said computer executable instruction which when run: control movement of said plurality of game objects using a physics engine, each game object being classified as moving or stationary; cause a position control part to receive physics engine information from said physics engine; and determine based on said physics engine information if a game object classified as moving is to be reclassified as stationary and if so providing classification information to said physics engine.

The computer executable instructions may be run on one or more processors.

### BRIEF DESCRIPTION OF THE DRAWINGS

FIG. 1 shows an example user device in which some embodiments may be provided;

FIG. 2 shows an example system in which some embodiments may be provided;

FIGS. 3 and 4 show schematic examples of game images displayed to the user;

FIG. 5 is a schematic diagram showing the modules and functions associated with carrying out the operating of embodiments;

FIG. 6 is a flow diagram depicting the method steps associated with embodiments;

FIG. 7 is a flow diagram depicting the method steps of some embodiments, of a position block of FIG. 5.

### DETAILED DESCRIPTION OF THE INVENTION

In the following description of various implementations, reference is made to the accompanying drawings which form a part thereof, and in which is shown by way of illustration various implementations may be utilized.

The terms user and player are used interchangeably throughout this document and no specific meaning is intended using one or the other unless the context suggests otherwise.

A person skilled in the art will realise that the different approaches to implementing the game is not exhaustive, what is described herein are certain preferred embodiments. It is possible to implement the game in a number of variations without departing from the spirit or scope of the invention.

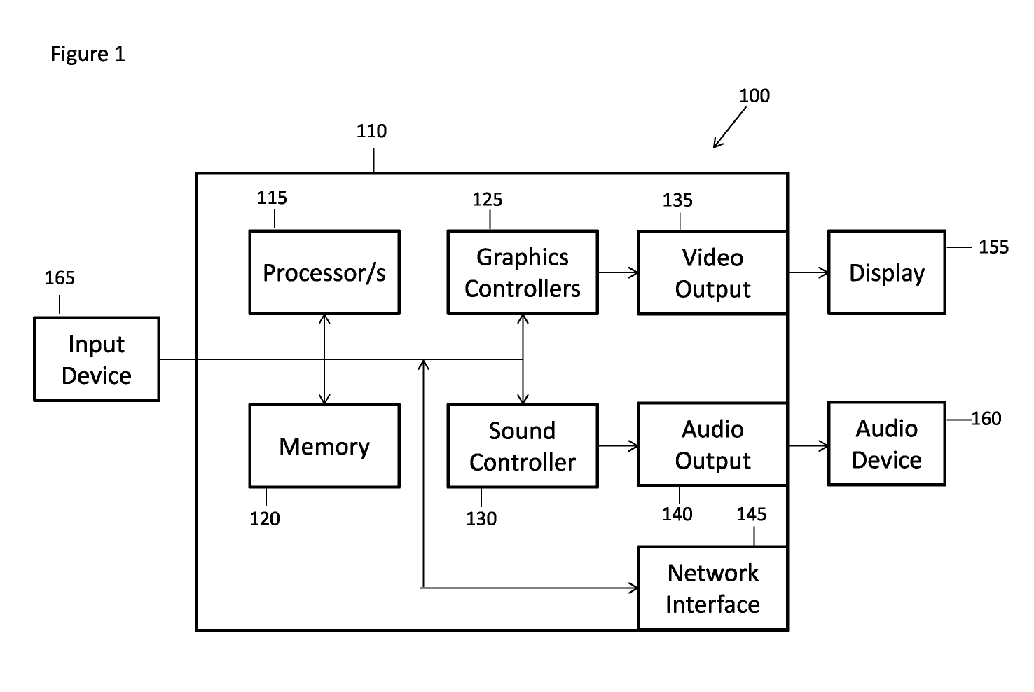

A schematic view of a user device 100 according to an embodiment is shown in FIG. 1. All of the blocks shown are implemented by suitable circuitry. The blocks may be implemented in hardware and/or software. The user device may have a control part 110. The control part 110 is also shown as having a graphics controller 125 and a sound controller 130. It should be appreciated that one or other or both of the graphics controller 125 and sound controller 130 may be provided by the one or more processors 115.

The graphics controller 125 is configured to provide a video output 135. The sound controller 130 is configured to provide an audio output 140. The control part 110 has an interface 145 allowing the device to be able to communicate with a network such as the Internet or other communication infrastructure.

The video output 135 is provided to a display 155. The audio output 140 is provided to an audio device 160 such as a speaker and or earphone(s).

The device 100 has an input device 165. The input device can take any suitable format and can be one or more of a keyboard, audio input, mouse, touch screen, joystick or game controller. It should be appreciated that the display 155 may in some embodiments also provide the input device 165 by way of an integrated touch screen for example.

The blocks of the control part 110 are configured to communicate with each other by an interconnect such as a bus or any other suitable interconnect and/or by point to point communication. The blocks of the controller may be implemented in any suitable way. The blocks of the controller may be regarded as schematically showing one or more functions performed by the control part 110.

It should be appreciated that in some embodiments, the control part may be implemented by one or more integrated circuits, at least in part.

The user device 100 is shown by way of example only. In alternative embodiments, one or more of the parts may be omitted. Alternatively or additionally, some embodiments may comprise one or more other parts. Alternatively or additionally, one or more parts may be combined.

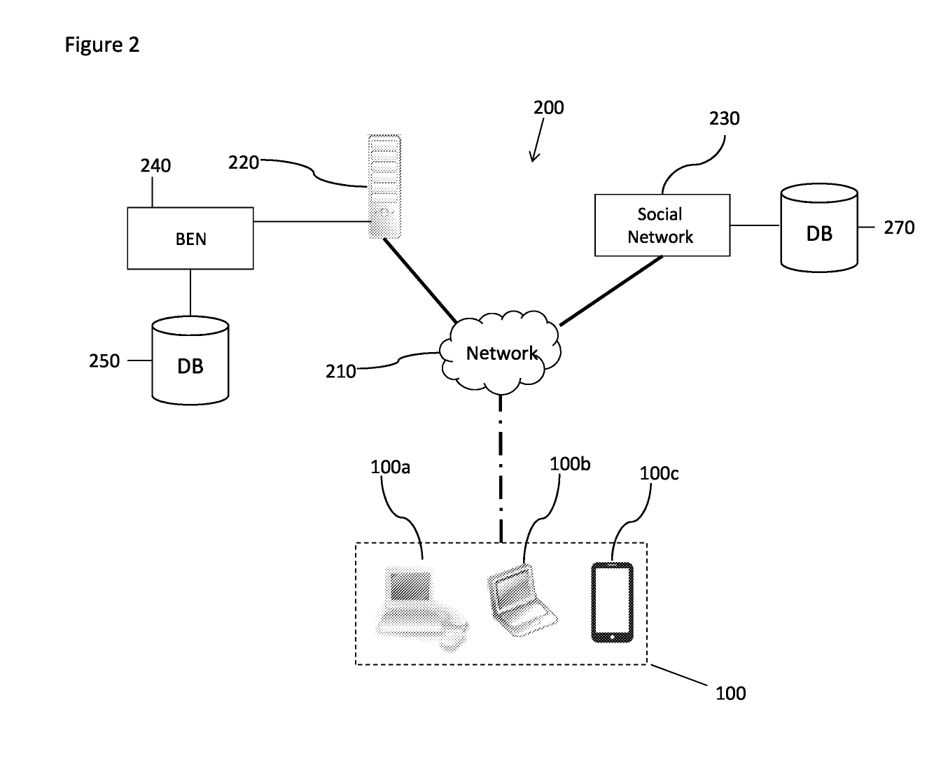

FIG. 2 schematically shows a system 200 according to an embodiment. The system 200 comprises a server 220 which may store or be in communication with database 250. A back end infrastructure (BEN) may be provided between the database 250 and the server 220. The database may store one or more of game player's details, profiles, statistics etc. In practice, one or more databases 250 may be provided. Where more than one server 220 is provided, the database(s) 250 may be provided in one database 250 or across two or more databases. The server 220 may have a games data function. This may comprise one or more units of memory to store the computer game program, user behaviour data and a processor 115 to run the games program and process the user behaviour data.

The server 220 may communicate via, for instance, a communications infrastructure 210 to one or more client or user devices 100, shown in FIG. 2 by way of example as user devices 100a, 100b and 100c. The communications infrastructure may be the Internet or the like. The communications infrastructure may provide connections to a social network 230, for example, Facebook™. The social network 230 may also be connected to a database 270 storing social user interaction details, for instance, user to user interaction maps, friend lists, location history etc. In practice, one or more databases 270 may be provided.

It should be appreciated that embodiments may be deployed in different system architectures. For example, the computer game may be implemented as a computer game that is stored in the memory of the user device and is run on the processor of the user device. However, the server 220 may handle some elements of the game in some embodiments. By way of example only, a Java game applet may be provided to the user device 200 and the locally running Java applet will generate, for example, the graphics, sounds, and user interaction for the game play on the user device. Some data may be fed back to the server to allow interaction with other players. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

It should be appreciated that some embodiments may be provided as stand-alone games on the user device. In that case, the game may be implemented at least partially by a computer program stored in memory on the user device and run by the control part 110.

As mentioned, some embodiments may be in the context of bubble shooting games. In general, known bubble shooting games shoot a bubble or game object upwardly towards an array of target bubbles. The movement of the bubbles in these types of game are relatively easy to control using a physics engine or the like since the main influence used to control the movement of a falling object displayed on the screen is a gravity property.

However in some embodiments, a bubble or game object is shot downwardly with respect to a target array of bubbles. The target array of bubbles is arranged with the bubbles in rows, with each adjacent row being offset with respect to any adjacent row. Controlling the movement of falling game objects in the displayed image is not straight forward. This is because the object is controlled so as to move according to a gravity property, needs to be come to rest in a defined position in a row and needs to be able to interact with the other objects (bubbles) to bounce off or roll down. Using only a physics engine to control this movement may require the physics engine to be complex. Physics engines which are complex are difficult to design, may be difficult to code and may be difficult to debug. Further there may be a limit on the computation power available for use by a physics engine, particularly where the game is to be played on a mobile device.

Some embodiments may reduce the complexity of the physics engine.

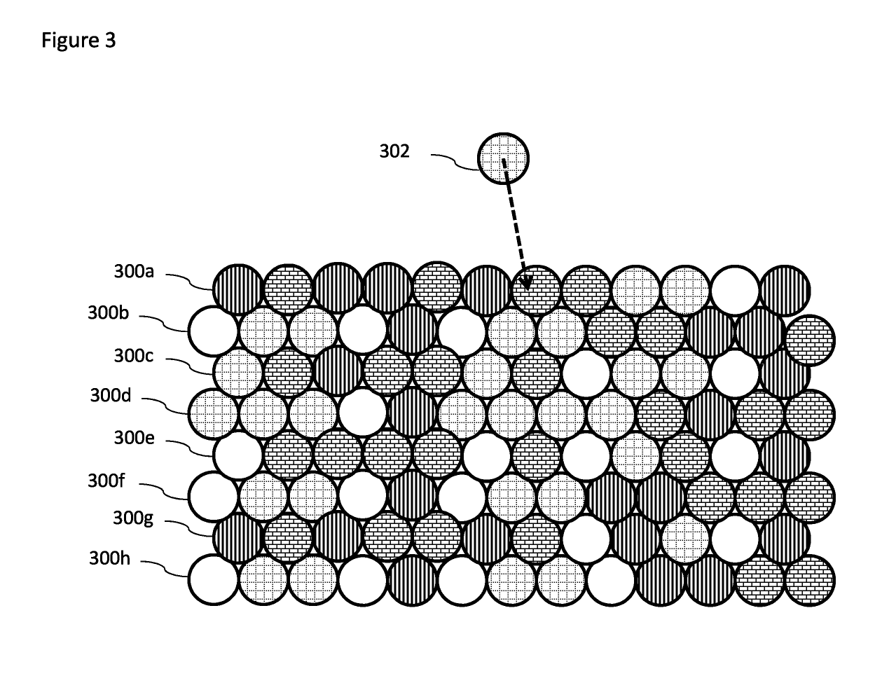

Reference is made to FIG. 3 which schematically shows an image displayed to a user playing a game of an embodiment. The image shows a number of rows 300a to h each of which contains a number of game objects. This mass of objects constitutes a target. As can be seen, the first row 300a is offset with respect to the second row 300b which is offset with respect to the third row 300c and so on. Generally, alternate rows are in alignment. This arrangement may be considered to define a hexagonal field.

In the arrangement shown in FIG. 3, each of the objects is shown with a respective pattern. This is to indicate that each object will have at least one attribute value which allows a user to distinguish objects having different attribute values of a given attribute. By way of example only, the property may be colour.

The arrangement, shown in FIG. 3, shows an object 302 which is to be fired at the target. The user, via the user interface, controls the direction in which the object 302 is released and when the object is released. Some embodiments may provide a device from which the object 302 is fired. The object 302 will move and come to rest against one or more objects. If three or more of the objects have the same property, i.e. the same colour, then those objects are removed.

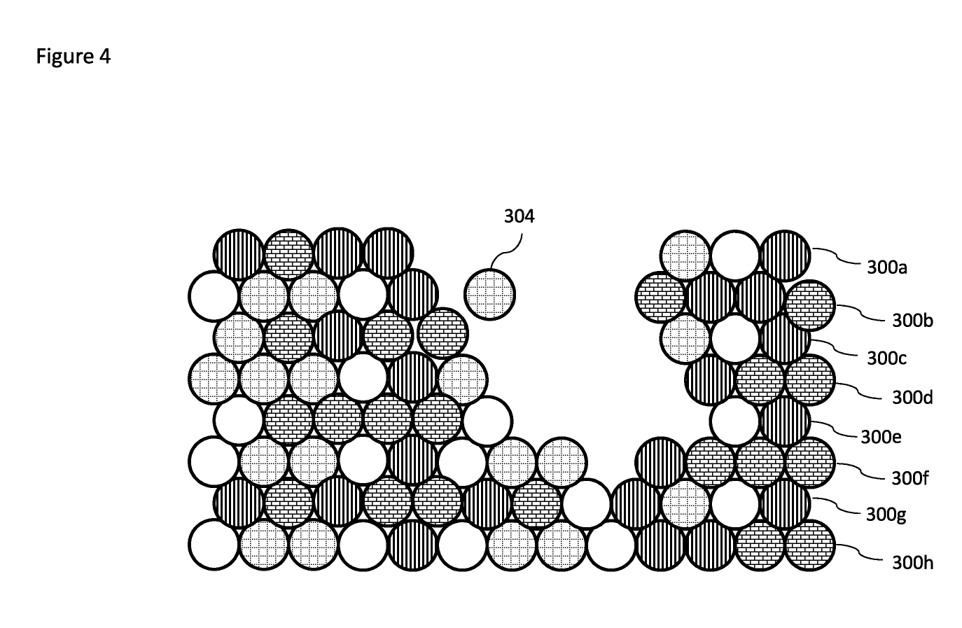

Reference is now made to FIG. 4. FIG. 4 schematically shows an image displayed to the user. As compared to the image shown in FIG. 3, several of the game objects have been removed. In FIG. 4, an object 304 is illustrated and is falling. As can be seen from FIG. 4, the falling object may fall vertically downwardly, under the property of gravity. However, when the object 304 collides with the target mass, that object 304 will continue to move. The movements may be for the object to roll down the angled surface of the target mass until it comes to a rest position.

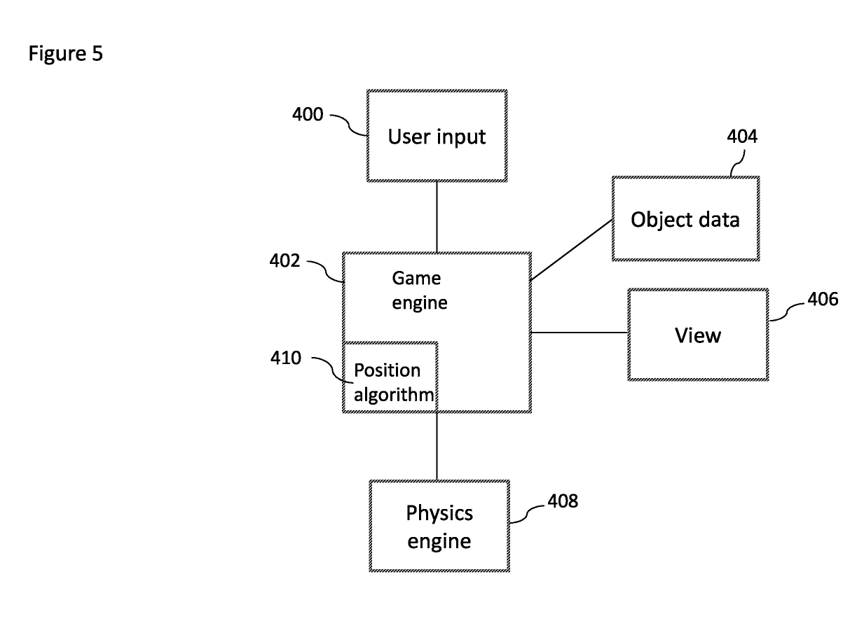

Reference is made to FIG. 5 which is schematically shows the functional blocks of an embodiment. A user input block 400 is shown. This captures the user input and feeds the input to a game engine 402. In the context of the bubble shooting game of some embodiments, this user input may be the direction in which the bubble is to be shot as well as the timing of the shooting of the bubble itself. This user input can be via any suitable user interface, such as discussed earlier.

The game engine 402 will process the information provided by the user input. The game engine 402 (for example a game model) will determine if a valid combination has been made.

Each object has object data associated therewith. The object data 404 may be stored in any suitable memory location. In some embodiments, the object data may be considered to be part of the game engine and in other embodiments may be considered to be outside the game engine. The object data may provide information as to the properties of an object. These properties can include attribute information such as colour and/or whether or not an object has a particular function such as a so-called booster function. The object data may include the position data, that is information representing the position of the object in the displayed image.

In some embodiments, the game engine will check if the game object satisfies the rule or rules for a valid match. The rule or rules which define whether or not a valid match has been made will be dependent on the game. In some embodiments, an object which has been moving and which has come to rest, will make a match if it shares an attribute with one game object and either of both of those game objects share an attribute with at least one other object. In some embodiments, this attribute may be colour. This object which is moving is an object which has been shot or which has been caused to move as a result of a previous match. In some embodiments, the game objects which match are removed.

Thus, the game engine will be in control of the matching mechanism. The game engine will have access to data for each bubble including its position and colour and will be able to determine if a match is made. If a match is made, the bubbles in the match are removed.

A physics engine 408 is provided which is configured to control the movement of the falling objects. This will be an object which has been shot or which has been caused to move as a result of a previous match. The physics engine will generally manage the movement of object based on for example gravity which controls the falling of the object, collision detection, when the falling object hits another object and optionally rotation calculations when the falling object rolls, for example, down the side of the other objects.

The movement of the object is thus controlled by the physics engine, which will control the movement of an object as it falls, rolls down other objects etc.

A position control block 410 is provided. In the embodiment shown, this position control block may be part of the game engine. In other embodiments, this position control block may be outside the game engine. The position control block may be provided by a position algorithm in some embodiments.

A view function 406 uses of the object data to provide the displayed image with which the user is able to view and/or interact.

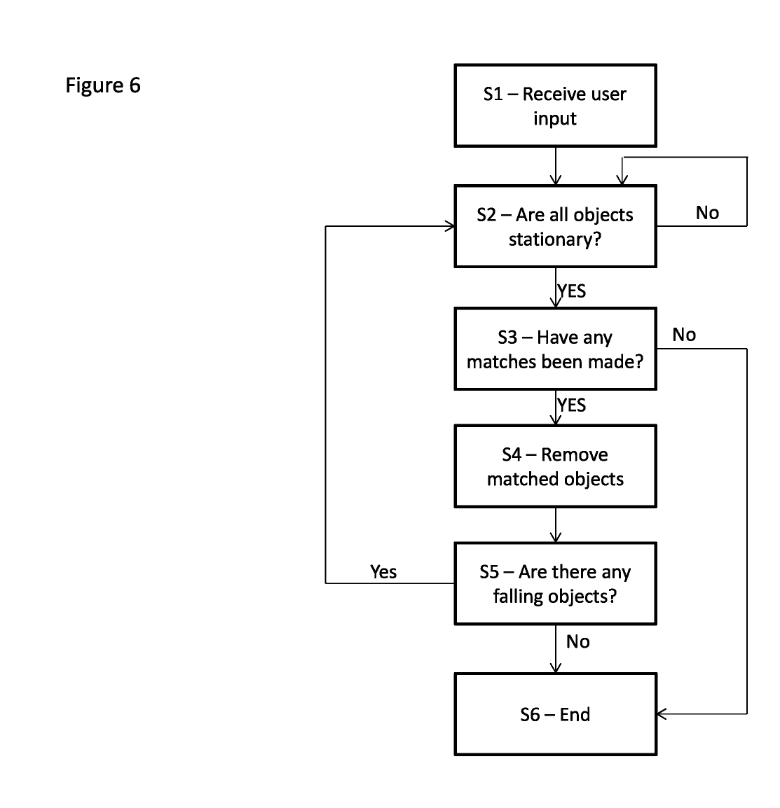

Reference is made FIG. 6 which shows a method of an embodiment.

In step S1, user input is received. This input is provided to the game engine. The input is used by the game engine to provide movement information to the physics engine to indicate which object has been shot and the direction information. Based on the input, the physics engine will control the movement of one or more objects. The physics engine will have information for each object. In particular, the physics engine will have information, which defines each object as either stationary or moving. If an object is classified as being stationary, the physics engine will not move that object. However, the physics engine needs to have information about the stationary objects in case of interaction of a moving object with the stationary objects.

Thus an object is classed as stationary or moving and this is used by the physics engine. The physics engine will control the moving bubbles but will take into account the position of the stationary bubbles to control the movement of the moving bubbles.

In step S2 a determination is made as to whether all objects are stationary. This determination is made in the position block dependent on information received from the physics engine. For example, an object may be considered to be stationary if it satisfies one or more conditions. The conditions can be any suitable conditions and may for example be that there has been little movement of an object in a period of time. There may be different sets of conditions defined and the satisfying of any one of those sets of conditions will mean that the object will be classified as stationary. The determination made in step S2 may be based on successive information provided by the physics engine.

If it is determined that all objects are stationary, then the next step is step S3. Otherwise, the check to see whether all objects are stationary will be repeated based on updated information from the physics engine. It should be appreciated that in some embodiments all the objects are stationary before step S3 is performed. In other embodiments, it may be enough if all the objects in one area are stationary—other objects may be moving in other areas.

In step S3, a determination is made as to any whether any matches have been made. This determination is made by the game engine. If not, then the turn is completed (step S6) and the game is ready for the user to shoot a new object.

If it has been determined that matches have been made, then the next step is step S4 and the matched objects are removed. This may result in one or more objects moving, falling and/or rolling down other objects.

In step S5, a determination is made as to whether there are any moving objects. Removal of an object may cause an iterative chain of: object falls, match is made; matched objects are removed; objects fall and so on. The removal of objects may result in one or more previously stationary objects adjacent to one or more removed objects to no longer have support and thus classified as moving objects. An object may be considered to be moving if the object is not in contact with a support (e.g. a ledge or target mass of objects which are not moving). If so, the method is repeated looping up to step S2. If not, then the turn is again ended and the next step is step S6.

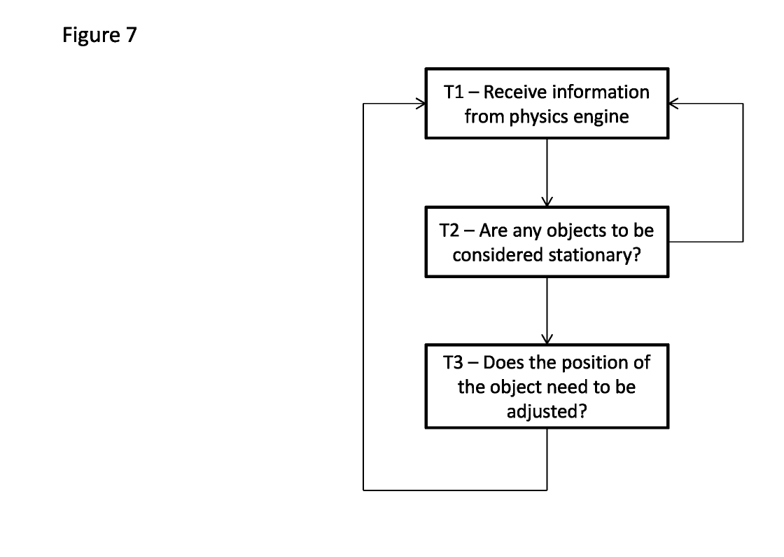

Reference is made to FIG. 7 which shows the method performed by the position block 410. This may be part of or comprise step S2 of FIG. 6.

In step T1, the position block will receive information from the physics engine. This information may be for the objects, which are considered to be moving objects. This information may be just for the objects, which are classified as moving objects, all the objects classified as moving and stationary or a subset thereof. One example of a subset would be all the objects classified as moving and a subset of the objects classified as stationary and which are in the region of the objects classified as moving. This information may be repeatedly provided by the physics engine. Based on the information received from the physics engine, a determination is made as to whether or not any objects are to be considered to be stationary.

The algorithm may use any suitable methods to determine if an object is considered stationary. For example, if an object (classified as moving) has not moved or only moved slightly over a given period of time, that object may be considered to be stationary. Alternatively or additionally the position of an object classified as moving with respect to one or more objects classified as stationary may be taken into account to determine if that moving object is now to be considered to be stationary.

In step T3, for any objects which are considered to be stationary, the position of that object may need to be adjusted. This is to ensure that the object is in the correct row position. The position block may change the position of an object to be in the correct position. Information about the changing of the categorisation of an object from moving to stationary and/or any adjustment of the position of a stationary object is fed back to the physics engine.

In some embodiments, the consideration of whether an object is considered to stationary can be used to determine if a moving object is in an allowed position with respect to stationary objects. If not, then the position block can adjust the position of an object. This may for example occur where there has been undercutting of objects under one or more other objects and/or where there is a supportive member provided with in the target mass.

Thus in some embodiments a hexagonal field is used for the objects which define positions for the stationary objects. The position block is used to determine if an object is stationary based on information from the physics engine and the hexagonal field. The position block will make sure that a moving object ends up in a hole or defined position in the hexagon field. For example if an object is close to a hole or defined position and is not moving, the algorithm will cause the position of the object to be updated so as to be in the hole or defined position. This updated position information will be fed back to the physics engine and the object will be classified as stationary.

The position block can be used to control one or more special cases where a bubble is leaning on another bubble or the like.

Thus, the position block will use information from the physics engine to determine if an object should be marked as stationary and if the position is to be adjusted to fall within a hole or defined position of the hexagonal field. This information is fed back to the physics engine.

The process between the algorithm and the physics engine is iterative.

Object data, will be provided in a respective memory location, contains the data from which the game characteristics are defined. By way of example only, the data may identify the position of one or more attributes of the object. One or more attributes may be provided. By way of example only, the attributes may be size, colour, character or the like of the tile. For example, the data comprises X (x coordinate information); Y (y coordinate information); a (where a is one of a set of numbers and each number represents a different colour). The attribute data may not itself be stored with the game object data. In other embodiments, the attribute data may be stored with the game object data. It should be appreciated that the attributes mentioned are by way of example and any suitable attributes may be used in embodiments, dependent on the game.

The example above has numeric values to represent the colour attribute. For example the number 1 may mean red. It should be appreciated that this is by way of example only and any other suitable method may be used to indicate the value or type of a particular attribute. In some embodiments, the data may have n bits where n represents each of the possible values of each of the possible attributes and 1 and 0 are used to indicate if the particular value of an attribute is present.

In some embodiments, a word or collection of letters may be used to indicate a value of the attributes.

Some embodiments have been described as having a hexagonal field. It should be appreciated that alternative embodiments may have differently defined locations for an object.

Some embodiments have been described in relation to a bubble shooter type game. It should be appreciated that other embodiments may be used with any other suitable games.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

An appropriately adapted computer program code product or products may be used for implementing the embodiments, when loaded on an appropriate data processing apparatus. The program code product for providing the operation may be stored on, provided and embodied by means of an appropriate carrier medium. An appropriate computer program can be embodied on a computer readable record medium. A possibility is to download the program code product via a data network.

In general, the various embodiments may be implemented in hardware or special purpose circuits, software, logic or any combination thereof.

Embodiments may thus be practiced in various components such as integrated circuit modules.

It is also noted herein that while the above describes embodiments, there are several variations and modifications which may be made to the disclosed solution without departing from the scope of the present invention.

1. A system for providing a computer implemented game having a plurality of game objects which in use are displayed on a display, said system comprising:
an input configured to receive an input from a user;
a game engine part configured to be responsive to the received input;
a physics engine configured to control movement of said plurality of game objects, each game object being classified as moving or stationary; and
a position control part configured to receive physics engine information from said physics engine and based on said physics engine information to determine if a game object classified as moving is to be reclassified as stationary and if so to provide classification information to said physics engine.

2. A system as claimed in claim 1, wherein said position control part is configured to determine if a game object which is to be reclassified as stationary is to have its position adjusted.

3. A system as claimed in claim 2, wherein game objects are arranged in a defined pattern and said position control part is configured to adjust a position of said game object to be reclassified to conform to said defined pattern.

4. A system as claimed in claim 3, wherein said defined pattern is a hexagonal field pattern.

5. A system as claimed in claim 2, wherein said position control part is configured to provide adjusted position information on said adjusted position, such that said adjusted position information is used by said physic engine.

6. A system as claimed in claim 5, wherein said physics engine is configured to use said adjusted position information to update a position of said respective game object and to use the updated position of said respective object when controlling movement of another game object.

7. A system as claimed in claim 1, wherein said physics engine and said position control part are configured to perform an iterative process to determine if a game object is to be reclassified as stationary.

8. A system as claimed in claim 1, wherein if it is determined that an object is not be reclassified, said position control part is configured to receive further physics engine information and use current and further physics engine information to determine if a game object is to be reclassified.

9. A system as claimed in claim 1, wherein said position control part is configured to determine that a game object is to be reclassified as stationary if one of a plurality of pre-defined conditions is satisfied.

10. A system as claimed in claim 1, wherein said position control part is configured to determine if the position of a game object which is to be reclassified as stationary has an allowed configuration with respect to one or more other game objects and/or a different game element.

11. A system as claimed in claim 1, wherein said game engine is configured to determine if one or more game objects satisfy one or more rules and if so to remove said one or more game objects.

12. A system as claimed in claim 11, wherein said game engine is configured to determine if one or more game objects satisfy one or more rules only if all of said game objects has been classified as stationary.

13. A system as claimed in claim 11, wherein after said one or more game objects has been removed, said position control part is configured to again receive physics engine information from said physics engine and based on said physics information to determine if an object classified as moving is to be reclassified as stationary and if so to provide said classification information to said physics engine.

14. A system as claimed in claim 1, wherein said game engine part comprises said position control part.

15. A system as claimed in claim 1, wherein said position control part is provided by an algorithm which is configured to run on a processor.

16. A method for providing a computer implemented game having a plurality of game objects which in use are displayed on a display, said method comprising:
controlling movement of said plurality of game objects using a physics engine, each game object being classified as moving or stationary;
receiving physics engine information from said physics engine; and
determining based on said physics engine information if a game object classified as moving is to be reclassified as stationary and if so providing classification information to said physics engine.

17. A method as claimed in claim 16, comprising determining if a game object which is to be reclassified as stationary is to have its position adjusted.

18. A method as claimed in claim 17, comprising adjusting a position of said game object to be reclassified to conform to a defined pattern.

19. A method as claimed in claim 17, comprising using, in said physics engine, adjusted position information to update a position of said respective game object and to use the updated position of said respective object when controlling movement of another game object.

20. A method as claimed in claim 16, if it is determined that an object is not be reclassified, receiving further physics engine information and to use current and further physics engine information to determine if a game object is to be reclassified.

21. A method as claimed in claim 16, comprising determining that a game object is to be reclassified as stationary if one of a plurality of pre-defined conditions is satisfied.

22. A method as claimed in claim 16, comprising determining if the position of a game object, which is to be reclassified as stationary, has an allowed configuration with respect to one or more other game objects and/or a different game element.

23. A method as claimed in claim 16, comprising determining if one or more game objects satisfy one or more rules only if all of said game objects has been classified as stationary.

24. An apparatus for providing a computer implemented game having a plurality of game objects which in use are displayed on a display said apparatus comprising at least one processor and at least one memory including computer code for one or more programs, the at least one memory and the computer code configured, with the at least one processor, to cause the apparatus at least to:
control movement of said plurality of game objects using a physics engine, each game object being classified as moving or stationary;
receive physics engine information from said physics engine; and
determine based on said physics engine information if a game object classified as moving is to be reclassified as stationary and if so providing classification information to said physics engine.

25. In combination, a physics engine and a position control part which is outside said physics engine, said physics engine configured to control movement of a plurality of game objects which are to be displayed, each game object being classified as moving or stationary, and said position control part is configured to receive physics engine information from said physics engine and based on said physics engine information to determine if an game object classified as moving is to be reclassified as stationary and if so to provide classification information to said physics engine.

26. A computer program product for providing a computer implemented game having a plurality of game objects which in use are displayed on a display, said computer program product comprising computer executable code which when run is configured to:
control movement of said plurality of game objects using a physics engine, each game object being classified as moving or stationary;
receive physics engine information from said physics engine; and
determine based on said physics engine information if a game object classified as moving is to be reclassified as stationary and if so providing classification information to said physics engine.
